(19) United States
(12) Patent Application Publication
(10) Pub. No.: US 2009/0151240 A1
(43) Pub. Date: Jun. 18, 2009

(54) Algae intensive cultivation apparatus and cultivation method

(75) Inventors: Hiroyuki Kayama, Osaka-shi (JP); Shusaku Kadowaki, Kagoshima (JP)

Correspondence Address: HAMRE, SCHUMANN, MUELLER & LARSON, P.C., P.O. BOX 2902, MINNEAPOLIS, MN, 55402-0902, US

(73) Assignee: NATIONAL UNIVERSITY CORPORATION KAGOSHIMA UNIVERSITY, Kagoshima-shi (JP)

(21) Appl. No.: 11/587,118

(22) PCT Filed: Apr. 18, 2005
(86) PCT No.: PCT/JP2005/007389

§ 371 Date: Oct. 20, 2006

(30) Foreign Application Priority Data
Apr. 20, 2004 (JP) 2004-124711

(51) Int. Cl. A01G 33/00

(52) U.S. Cl. 47/1.4

(57) ABSTRACT

An apparatus for carrying out algae intensive-cultivation while conducting an environmental control most suitable for growth of algae in an artificial environment including dissolved gas, light, temperature, nutrient source and sanitary atmosphere; and a method of intensive cultivation therewith. There is provided an apparatus comprising water tank (1) for cultivating unialgae as seedling; gas dissolution diffusion units (3-a, 3-b) for achieving dissolution of a gas in a culture water of the water tank; light irradiation units (10, 11) for irradiating the water tank with light whose wavelength and illuminance are controlled; temperature control unit (20) for controlling the temperature of the culture water of the water tank so as to fall within a given range; nutrient salts adding unit (17) for adding to the water tank a nutrient liquid containing an essential nutrient source vital to the growth of algae; purification unit (12) for carrying out bacterial eradication and filtration of the culture water of the water tank; and meters for control of the above units.

### TECHNICAL FIELD

The present invention relates to a land-based aquaculture system for algae, and in particular to a land-based aquaculture apparatus and method for forcing the cultivation of algae by artificially controlling the entire growing environment.

### BACKGROUND ART

Because of abnormal weather events, habitat destruction caused by development, and ocean contamination, etc., production of algal resources that the Japanese have been using as foods since time immemorial, e.g., “Wakame” (Undaria pinnatifida), “Kombu” (Laminaria japonica) and “Nori” (Prophyra tenera) has become unstable. Because of the worsening environment of rivers, edible riverweeds are facing a danger of extinction.

As a countermeasure to these problems, research and development of land-based culture has been conducted from the viewpoints of stability and safety (e.g., patent documents 1-3 below).
Patent Document 1: JP-A-2002-320426
Patent Document 2: JP-A-2002-315568
Patent Document 3: JP-A-10-117628 (1998)

Patent Document 1 discloses: “A marine algal culture apparatus characterized in that a semi-perpendicular-arranged hollow pipe and an aeration device that is located at the lower end of said hollow pipe and functions as an air blowing bubble pump are arranged inside a marine algal culture tank in which marine algae and seawater are contained and said marine algae is irradiated with light from a light source; wherein the seawater is aerated by the bubbles blown out from the bubble pump and the bubbles are mixed with the seawater inside the hollow pipe, raising the seawater inside the hollow pipe and discharging it from the discharge outlet in the upper part, while at the same time drawing up seawater from the inlet at the lower part of the hollow pipe and circulating the seawater inside the marine algal culture tank, thereby putting the marine algae in the circulation of the seawater and floating them in the marine algal culture tank” (claim 1 of the patent application)

Patent Document 2 discloses: “A culture method characterized in that effluent from a cultivation tank is guided to an algal culture tank for culturing algae, and nitrogen and phosphate contained in the effluent from the cultivation tank are taken into the algae as nutrition in the algal culture tank, thereby treating the effluent from the culture tank; the algal culture water is condensed by separating its solids in a membrane filter and the condensed algal culture water is supplied to a plankton culture tank, and in the plankton culture tank, planktons are cultured using the algae as nutrition, and the plankton culture water is condensed by separating its solids in the membrane filter and the condensed plankton culture water is supplied to the culture tank as feed, or taken out of the system as a feed product.” (claim 1 of the patent application)

Patent Document 3 discloses: “A method for increasing and culturing marine algae in a land-based tank characterized in that a marine algal culture panel is built in the area near the seabed where marine algae increase and propagate, and marine algal seeds are planted so that they survive naturally and then moved to the land tank into which fresh seawater is introduced.” (claim 7 of the patent application)

### DISCLOSURE OF THE INVENTION

### Problems to be Solved by the Invention

The sunlight diffuses in the seawater and therefore the light decreases as the depth increases. The same is true with the water temperature. It becomes lower as the depth increases. The depth also influences the nutrients and gases such as carbon dioxide and oxygen dissolved in the seawater. Different types of algae grow at different depths and are said to form a vertical distribution. The best growth conditions for these algae under the vertical distribution differ from type to type. Basically, each type of algae has its own best environmental condition for growth with regard to the water temperature, light intensity, dissolved gas contents and nutrients concentrations, which are closely related to each other. Therefore, if one of them drops out, the growth is markedly suppressed. Therefore, for successful land-based forced culture, these environmental conditions must be adequately controlled.

According to the aforementioned traditional techniques, however, virtually no consideration, or insufficient consideration, if any, is given to these aspects. For example, according to one of the aforementioned traditional techniques, the condition of cultured algae is influenced by the water temperature and sunlight, which are part of the natural environment. If the temperature is too low or the sunshine duration is too short because of abnormal weather events, the cultivation time becomes longer, or worse, the algae that are cultured may die. In the above technique, large amounts of seawater are drawn up in order to culture algae on the land, but since this technique also uses large amounts of liquid fertilizer, it causes sea pollution. Furthermore, because algae are cultured in dense conditions, they are prone to plague. Because of these factors, the traditional land-based aquaculture is accompanied by a serious defect that is unstable cultivation.

### Means to Solve the Problems

The apparatus for forced culture of algae of the present invention is aimed at solving the above problems and comprises a water tank in which filaments, sporophytes or gametophytes of algae are cultured as algal seeds; a gas dissolving and diffusing device for dissolving gas in the cultured water of said tank; a light-radiating device for irradiating said water tank with light, whose light-quality balance and illuminance are controlled; a temperature-controlling device for controlling the temperature of said cultured water within a certain range, a nutrients adding device for adding to said cultured water nutrients containing essential nutrients that are indispensable for the growth of algae; a device for purifying said cultured water, and a measurement device for controlling these devices (claim 1).

The method for forced culture of algae of the present invention is a method for culturing algae in a water tank using filaments, sporophytes or gametophytes of algae are used as algal seeds, and comprises a step for dissolving gas in the culture water in said tank, a step for irradiating said water tank with light from a light source, whose light wave length, light-quality balance and illumination are controlled, a step for controlling the temperature of said culture water within a certain range, a step for adding to said cultured water nutrients containing essential nutrients that are indispensable for the growth of algae, and a step for disinfecting and purifying said culture water (claim 11).

### EFFECTS OF THE INVENTION

The embodiment described below is about the cultivation of “sea grapes”. According to an experiment conducted for the present invention, the “sea grapes” grown according to the present invention gained more than three times as much weight as those of the control plot. The quality of the sea grapes was also good.

As evident from these findings, forced culture of safe and good quality algae, which was difficult to achieve using the traditional culture techniques, has become possible by using the present invention. The apparatus and methodology according to the present invention constitute a plant factory of algae, in other words, an aquatic vegetable plant.

### BEST MODE OF CARRYING OUT THE INVENTION

The groups of algae to which the present invention can be applied include edible algae belonging to such classes as the brown algae, the green algae, the red algae and the blue algae (claim 12). Caulerpa lentillifera, a delicacy commonly known as “sea grapes”, belonging to Caulerpales is an example (claim 13).

There are three elements that are indispensable for the growth of algae: light, nutrients and water temperature. These elements will now be explained one by one below.

### Control of Light

Like land-based plants, algae also react to light, and this characteristic influences their growth and quality significantly. When red light (600 nm-780 nm), green light (500 nm-600 nm) and blue light (400 nm-500 nm) are radiated as the wavelengths of light that are necessary for photosynthesis and morphogenesis, photoreceptors such as chlorophyll, phytochrome and carotenoid are stimulated and influence photosynthesis and the growth of algal organ structures such as leaves and stems. But in order to promote the growth of algae and grow them normally, it is preferable to radiate mixed light of the three wavelengths rather than light of a single wavelength, because a single color light can cause abnormal formation of algal organ structures and bronzing (claim 2). The preferable light energy ratios of red, blue and green differ from algae group to algae group. For green algae, the preferable energy ratios of red, blue and green are approximately 2±1:3±1:5±1. In the case of brown algae, the preferable energy ratios of red, blue and green are 3±1:2±1:5±1. The illuminance at which the light source of these light qualities is radiated to algae is within the range of 20-400 μmol/m²/s, which is the illuminance necessary for algae in general to grow. But the preferred illuminance depends on the habitat of the algae in question. For example, the preferred illuminance is 140-200 μmol/m²/s for amanori, which belongs to the red algae group, 40-200 μmol/m²/s for “Kombu” (Laminaria japonica), which belongs to the brown algae group, and 100-120 μmol/m²/s for Caulerpa lentillifera, which belongs to the green algae group.

In order to control the wavelength, three-color composites and illuminance of these colors of light, it is convenient to use light-emitting diodes, semiconductor laser, metal halide lamps and high-pressure sodium lamps as the light source. Currently metal halide lamps and high-pressure sodium lamps are provided at affordable prices. In order to get an accurate light balance, however, light-emitting diodes are superior. Light-emitting diodes can provide an accurate light quality balance, so for a forced culture of algae, it is appropriate to embed light-emitting diodes that emit desirable wavelengths in the upper part (e.g., ceiling) of the water tank and use them as the light source (claim 2). Through this arrangement, it is possible to control three types of light-emitting diodes of respective wavelengths using an inverter and at the same time control the illuminance.

When radiating such controlled light to algae, continuous irradiation can lower their photosynthetic capacity. In other words, the plant's physiological metabolism becomes abnormal, causing photoinhibition. Therefore, it is preferable to radiate light in light/dark cycles rather than continuously. In the light period (photoperiod), algae absorb carbon dioxide and perform photosynthesis, synthesize and store carbohydrates; in the dark period, algae metabolize actively in their bodies. They absorb oxygen from the water, burn the oxygen and carbohydrates in their bodies, produce energy and discharge carbon dioxides. The duration of the light/dark cycle differs from algae group to algae group, but the total photoperiod time for a day is appropriately 5 to 24 hours, or more preferably 12 to 24 hours (claim 3).

### Controlling the Gas Density

Like land-based plants, algae grow by repeating the processes of photoirradiation, photosynthesis and absorption of carbon dioxide in the photoperiod and respiratory metabolism through which oxygen is absorbed in the dark period. Therefore, by varying the carbon dioxide density and the oxygen contents that are necessary for light/dark cycles between the light period and the dark period, an environment optimized for the growth of algae is obtained.

According to the present invention, carbon dioxide is obtained by using a carbon dioxide bomb available on the market, or by burning fossil fuel or biomass. A carbon-dioxide-generating device that generates carbon dioxide by burning fossil fuel is commercially available. Oxygen can be obtained as condensed oxygen by using a type of oxygen-generating device that condenses atmospheric oxygen using a gas-separating film (claims 4, 5).

These gases are introduced into an air diffuser and dissolved and diffused into the water as micro fine bubbles. A pump is also used to produce a water flow to diffuse the gases. The gas densities at this time are measured using a carbon-dioxide-gas-density meter and a dissolved-gas-density meter that are commercially available, and using the output signals, the electromagnetic valve of each tube is controlled (claim 10). In the photoperiod of the light/dark cycle, the dissolved carbon dioxide density is 100-500 ppm, or preferably 150-300 ppm, and in the dark period, carbon dioxide is stopped and instead air including oxygen is introduced. At this time, the oxygen density is controlled to be between 5 ppm and 20 ppm (claims 5, 6).

### Replenishing of Nutrient Salts

Besides controlling light and the gas density, it is necessary to control the nutrients concentrations of the culture water and replenish it with nutrients required by the algae.

Normally, algae absorb nutrients dissolved in the water from their leaves. In the case of seaweeds cultured in a culture device for algae, artificial seawater or filtrated seawater is used as culture water. Therefore, when the seaweeds have absorbed all the trace minerals in the water, their growth slows. In order to solve this problem, it is necessary to either resupply seawater from outside or replenish the culture water with necessary nutrients. Liquid into which nutrients necessary for the growth of algae are mixed and dissolved is called “nutrient liquid” in this document.

Essential nutrients that are indispensable for the growth of algae are nitrogen, phosphate and potassium, the same as those for land-based plants. These nutrients are commercially available as nutrients for either land-based plants or seaweeds. To prepare them, ammonium (ammonium sulfate, ammonium nitrate, etc.) are used as a nitrogen source, phosphates (superphosphate, Thomas phosphate, etc.) are used as a phosphorous source, and potassium (potassium sulfate, potassium chloride, potassium nitrate, etc.) are used as a potassium source, and these minerals are mixed and dissolved according to the component ratios of organic elements, N, P and K of algae. For example, in the case of sea grapes, the ratios of N:P:K are 4:2:3, so nitrogen, phosphate and potassium are dissolved in filtrated seawater or clean water to prepare nutrient liquid. PES culture medium and Yashima medium, which are obviously used as seaweed and phytoplankton culture mediums, can also be referred to, to prepare nutrient liquid.

In addition, vitamins and growth hormones can also be added and prepared to the nutrient liquid.

When dripping this nutrient liquid to algal culture water, one of the essential nutrients contained in the culture water—nitrogen, phosphate or potassium—is measured beforehand and used as an index, and the nutrient liquid is dripped periodically in order to compensate for the lack of nutrients that are absorbed by the algae as they grow (claim 8).

### Disinfecting and Filtrating

Normally, a water tank for culturing algae is in a condition in which microalgae such as diatoms and bacteria can multiply in addition to the group of algae that is intended to be cultured. These adherent algae, microalgae, protozoa and bacteria compete with and prevent the growth of the objective algae inside the culture tank. And because the algae are cultured in a dense condition, if a plague derived from bacteria occurs, culture becomes difficult. As a countermeasure, this culture water is disinfected and filtrated.

For disinfection and filtrating, it is preferable to use a filtrating device including an MF (microfiltration) membrane or UF (ultrafiltration) membrane (claim 9). Such a membrane can filter particles smaller than 0.1 micron. Using such a membrane, even viruses can be eliminated. Using this membrane, an amount of culture water that completely displaces the existing water at least once every two days but not more than once every six hours is filtrated. This frequency of filtration applies to filtration of either circulating or running culture water. In order to extend the service life of the MF or UF membrane, a pre-process device such as a sand-filtrating device or a 5-10 micron filtrating membrane is attached before the MF or UF membrane.

### Temperature Control

According to the present invention, it is preferable to control the temperature by using a steam or electric heater, warm underground water, boiler, solar-heating warm-water producing device or heat storage water tank to raise the water temperature, and cool underground water or a chiller device to lower the water temperature.

Each of these devices are composed of a heat exchanger that exchanges heat of the culture water using a heat source or a cooling source, to control the temperature of the culture water preferably between 5° C. and 35° C. (claim 7).

### Automatic Control of Each Device

It is preferable to assemble a circuit that automatically controls the aeration, water temperature and illuminance according to the input of signals from a dissolved gas contents meter, a thermometer, a photometer and a meter for measuring the density of the index substances of the nutrient liquid (claim 10). These measurement devices and the automatic control device may be of the kinds that are publicly known.

The present invention will now be described by reference to the accompanying drawings.

### BRIEF DESCRIPTION OF THE DRAWINGS

FIG. 1 is a schematic drawing of a forced culture apparatus for algae according to an embodiment of the present invention.

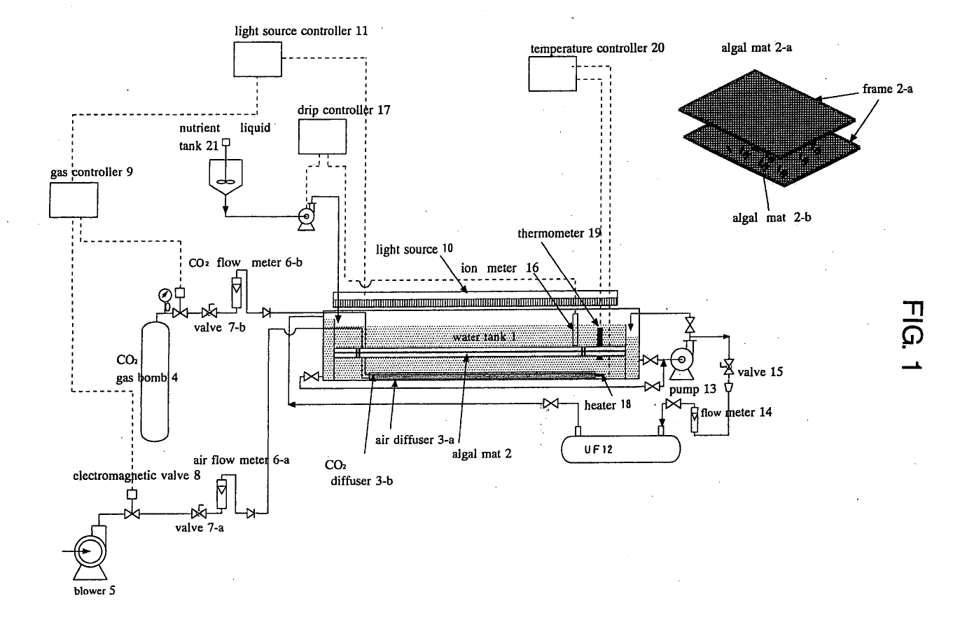

FIG. 2 is a graph showing the growing speed of “sea grapes” represented by the average weight.

### EXAMPLE 1

The cultured alga is Caulerpa lentillifera, which is an edible alga commonly known as “sea grape” occurring in the waters near or to the south of Okinawa.

In a culture water tank 1 measuring 150 cm×100 cm×30 cm (L×W×H internally) and having a capacity of 450 litres, a mother algal mat of 100 cm×100 cm is fixed at a depth of 15 cm. The mother algal mat 2 is made by bedding mother algae 2-b at 15 kg/m² on a frame 2-a over which a culture net (of synthetic fiber) of 8 mm meshes is spread. The mother algae are sandwiched by two culture nets, and the frame is fastened with tools so its four comers do not open. This sandwich structure containing the mother algae within has a net-to-net distance of 2 cm. This frame with the mother algae and the two nets sandwiching them shall be called “mother algal mat 2” in this document.

At the bottom of the culture water tank 1, an air diffuser 3-a for diffusing air into the water and a carbon dioxide diffuser 3-b for diffusing carbon dioxide into the water are fixed. These devices are made of resin and each is made of three tubes having dimensions of 6 cm diameter by 20 cm length joined together. The air diffuser 3-a's purpose is to dissolve atmospheric oxygen in the water as well as to agitate the water. On the other hand, the carbon dioxide diffuser 3-b's purpose is to dissolve carbon dioxide in the water. In this embodiment, a carbon dioxide bomb 4 is used to supply carbon dioxide. The air that is supplied to the air diffuser 3-a is obtained from a blower 5. The gas contents of each device is adjusted by adjusting the supply flow of an air flow meter 6-a and a carbon dioxide flow meter 6-b. The air flow meter 6-a is adjusted by a valve 7-a so that the dissolved oxygen contents of the liquid in the water tank is 5-10 ppm. The carbon dioxide flow meter 6-b is adjusted by a valve 7-b so that the dissolved carbon dioxide contents in the water tank is 150-200 ppm. Air bypass electromagnetic valves, specifically, an air electromagnetic valve 8-a and a carbon dioxide electromagnetic valve 8-b are provided. In the photoperiod, the carbon dioxide electromagnetic valve 8-b opens and the air electromagnetic valve 8-a closes. In the dark period, the air electromagnetic valve 8-a opens and the carbon dioxide electromagnetic valve 8-b closes. A gas controller 9 is provided to control the opening and closing of these valves.

The water in the water tank is heated by a heater 17. For cultivation of sea grapes, a water temperature of 26-30° C. is preferred. In this embodiment, a thermometer 18 is used to measure the water temperature. A temperature controller 19 is used to control the heater 17, which maintains the water temperature at 28±1° C.

A light source 10 is established at the top of the culture water tank 1. This light source 10 comprises three light-emitting diodes of red, green and blue, arranged in parallel. The light source 10 is accompanied by a light-source controller 11, which controls the ratios of the energies of red, green and blue to be at 2:3:5. The illuminance of the light source is controlled to be at 140 μmol/m²/s at 15 cm below the surface of the water. The light/dark cycle is controlled to be 20 hours of the photoperiod versus 4 hours of the dark period.

A UF filtration device 12 is used to purify the seawater. A pump 13 is operated and a flow meter 14 is adjusted by a valve 15 so that the filtration flow becomes 0.6 litres/min. The filtration capacity of the UF membrane is 0.01 micron, so it is possible to filtrate bacteria and viruses.

The nutrient liquid to be dripped to the culture water tank is prepared by adding ammonium nitrate and ammonium phosphate as a nitrogen (N) source, calcium phosphate as a phosphorous (P) source, and potassium chloride as a potassium (K) source, at ratios of 4% (N):2% (P):3% (K). The nutrient liquid is stored in a nutrient-liquid tank 20. The amount of the nutrient liquid to be dripped is measured using dissolved total nitrogen (DTN), which is one of identified nutrient sources contained in the nutrient source, as the index. The density of the dissolved total nitrogen (DTN) is used to set the base value of the dissolved total nitrogen (DTN) of the culture water, and the dissolved total nitrogen (DTN) in the culture water is controlled by a nutrient salt dripping device 16 so that the ratios of the nutrient salts N, P and K in the culture water are always constant. In this embodiment, the density of dissolved total nitrogen (DTN) is adjusted so that it is always within the range of 1.0 ppm and 3.0 ppm. The culture water is changed once a day.

Using the above-described culture apparatus, sea grapes were cultured for twenty days. Besides this, a heater, a UF membrane filtration device and an air diffuser for agitation were installed in the same type of culture water tank in a control plot, and fresh seawater was changed every day. Natural light was used as the light source. A natural environment in which algae absorb nutrients from the seawater was simulated to culture sea grapes, with only the water temperature and the UF membrane conditions adjusted to those of the culture apparatus described in the embodiment.

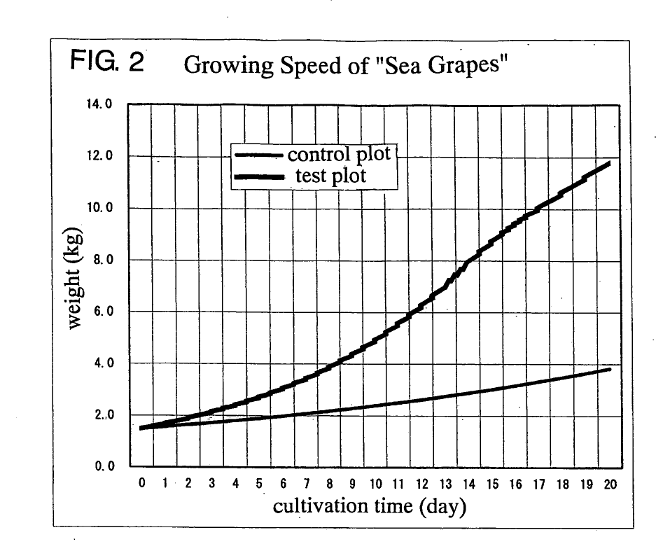

In order to observe the growth, the weight of the sea grapes was measured every day. The average weight of the sea grapes is shown in FIG. 2. The weight of the “sea grapes” in the control plot grew 2.6 times in twenty days. “Sea grapes” cultured according to the embodiment of the present invention increased 7.6 times, which is 3.1 times as large in terms of weight compared to the growth in the control plot. The quality of the “sea grapes” was also good. The best harvest time is when the straight part of the stem is between 5 cm and 10 cm. When it is longer than 5 cm, the “sea grapes” can be harvested. Using the culture apparatus of the present invention, the “sea grapes” reached the best harvest time within about 14 days as opposed to the control plot.

According to the present invention, it is possible to grow safe and good quality algae in a short period of time, which was difficult using the conventional cultivation techniques.

1. An apparatus for forced culture of algae comprising a water tank in which filaments, sporophytes or gametophytes of algae are cultured as algal seeds; a gas dissolving and diffusing device for dissolving gas in the cultured water of said tank; a light-radiating device (10, 11) for irradiating said water tank with light, whose light-quality balance and illuminance are controlled; a temperature-controlling device (20) for controlling the temperature of said cultured water within a certain range, a nutrients adding device (17) for adding to said cultured water nutrients containing essential nutrients that are indispensable for the growth of algae; a device for purifying said cultured water (12), and a measurement device for controlling these devices.

2. An apparatus according to claim 1 in which the light-radiating device (10, 11) comprises light-emitting diodes, semiconductor laser, metal halide lamps or high-pressure sodium lamps emitting specific wavelengths of red (600-780 nm), green (500-600 nm) and blue (400-500 nm).

3. An apparatus according to claim 2 in which the light-radiating device (10, 11) irradiates the surface of algal leaves at an illuminance of 20-400 μmol/m²/s, and the illuminance and the light/dark cycle can be adjusted, and the total irradiation time per day is between 5 hours and 25 hours.

4. An apparatus according to claim 3 in which the gas dissolving and diffusing device includes a dissolving and diffusing device (3-a) for air that contains oxygen or air that contains oxygen condensed by a nitrogen gas membrane and a diffusing device for diffusing gas using running water and is controlled by the light/dark cycle of the light-radiating device.

5. An apparatus according to claim 4, in which the gas dissolving and diffusing device includes dissolving and diffusing devices (3-a, 3-b) for air that contains oxygen or air that contains oxygen condensed by a nitrogen gas membrane and carbon dioxide and a diffusing device for diffusing each gas and is controlled by the light/dark cycle of the light-radiating device in such a way that the carbon dioxide concentration increases during the photoperiod and during the dark period carbon dioxide is stopped and air that contains condensed oxygen is dissolved.

6. An apparatus according to claim 5 in which the density of carbon dioxide dissolved in the culture water is 100-500 ppm during the photoperiod and the density of dissolved oxygen during the dark period is 1-20 ppm.

7. An apparatus according to claim 1 in which the temperature-controlling device (20) comprises a heater (18) or warm underground water and a solar-heating warm-water producing device and a heat storage water tank to raise the temperature, and cool underground water or a chiller device to lower the water temperature, each being composed of a heat exchanger that exchanges heat of the culture water using a heat source or a cooling source to control the temperature of the culture water at a certain level within the range of 5° C. and 35° C.

8. An apparatus according to claim 1 in which the nutrients are dissolved and added in constant amounts to the algal culture water in order to promote the growth of the algae.

9. An apparatus according to claim 1 in which the device for purifying the culture water is a filtration device (12) including an MF membrane (microfiltration membrane) and a UF (ultrafiltration membrane).

10. An apparatus according to claim 1 in which the measurement device for these devices comprise a dissolved gas density meter for measuring the dissolved carbon dioxide and oxygen, a thermometer (19) and an illuminance meter, as well as a circuit for automatically controlling the carbon dioxide and oxygen contents, temperature and illuminance according to the input of signals from these meters.

11. A method for forced culture of algae in a water tank (1) using filaments, sporophytes or gametophytes of algae as algal seeds, comprising a step for dissolving gas in the culture water in said tank, a step for irradiating said water tank with light from a light source, whose light wavelength, light-quality balance and illuminance of blue, red and green are controlled, a step for controlling the temperature of said culture water within a certain range, a step for adding to said cultured water nutrient liquid containing essential nutrients that are indispensable for the growth of algae, and a step for purifying said culture water.

12. A method as described in claim 11 in which the algae are edible aglae belonging to the brown algae class, green algae class, red algae class and the blue algae class.

13. A method as described in claim 12 in which the algae are “sea grapes” (Caulerpa lentillifera).
